(19) United States
(12) Patent Application Publication
(10) Pub. No.: US 2004/0042202 A1
(43) Pub. Date: Mar. 4, 2004

(54) BULB ASSEMBLY WITH MULTIPLE SHELLS

(76) Inventor: Kuo-Fen Shu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/227,826

(22) Filed: Aug. 27, 2002

(51) Int. Cl. F21S 6/00

(52) U.S. Cl. 362/122; 362/255; 362/806

(57) ABSTRACT

The present invention relates to a bulb assembly with multiple shells, which includes a bulb and a holder and a patterned shell. The patterned shell can be formed by two or more shell units to obtain a beautiful outlook and it can be manufactured easily and economically. A various assembled patterned shell can be made sufficiently.

### BACKGROUND OF THE INVENTION

A light string always includes an electrical wire connecting with several bulb assemblies. Each bulb assembly includes a holder, and a bulb, which has a monotonous outlook. It is known that a patterned shell, such as a flower shape, a star-like shape, and so on, is provided on the bulb assembly to increase the decorative purpose. But the manufacturing procedure of such patterned shell is very difficult and expensive. It is not utilized.

Accordingly, the primary object of the invention is to provide a bulb assembly with multiple shells including two or more simple units for being assembled to form a beautiful outlook. Now the features and advantages of the present invention will be described in detail with reference to the accompanying drawings.

### BRIEF DESCRIPTION OF ACCOMPANYING DRAWINGS

FIG. 1 is an exploded cross-sectional plan view showing a bulb assembly with two shell units according to the present invention.

FIG. 2 is an assembled plan view of FIG. 1.

FIG. 3 is a top plan view of FIG. 2.

### DETAILED DESCRIPTION OF PREFERRED EMBODIMENTS

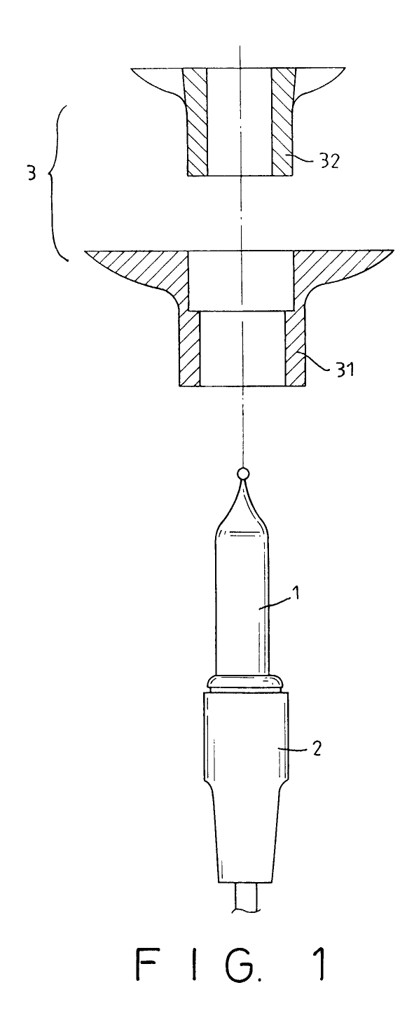

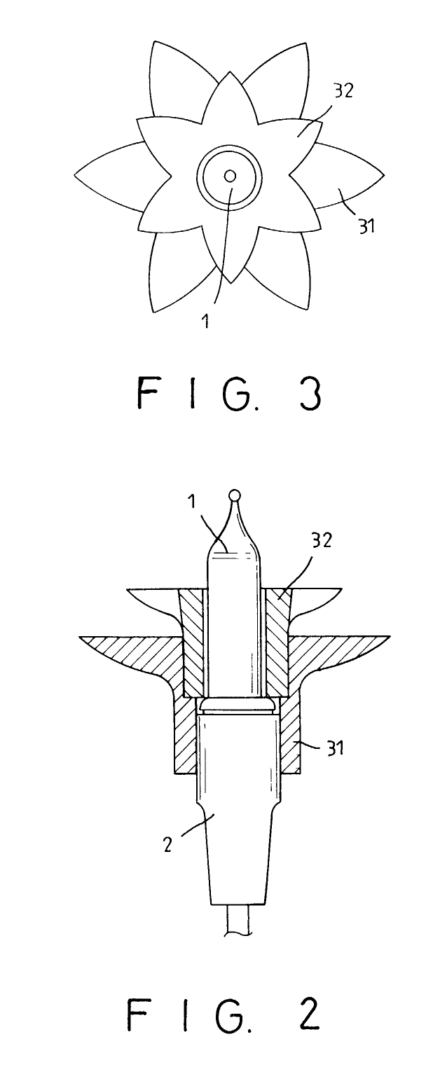

Please refer to FIG. 1 to 3, the present invention relates to a bulb assembly with assembled multiple shell units. The bulb assembly includes a bulb (1) received in a holder (2). The characteristic of the present invention is to provide an assembled shell (3) outside the bulb (1) and the holder (2). The assembled shell (3), in this embodiment, has a first unit (31) and a second unit (32), wherein the lower end of the second unit (32) is tightly engaged with the first unit (31) and the holder (2) can be engaged with the lower inner hole of the first unit (31). As the bulb (1) upward extends through the second unit (32), the two assembled units (31) and (32) become a flower shape shell (3) having a very beautiful outlook.

Since each unit has a simple structure, it can be manufactured in ease and economic. The unit can be assembled easily and firmly too. Moreover, the present invention can be completed with more than two units for forming a better decorative effect.

Accordingly, the present invention obviously achieves utility and improvement and should be allowed for patent.

What is claimed is:

1. A bulb assembly with multiple shells including a bulb and a holder and a patterned shell being provided outside the holder and the bulb; the characteristic is the patterned shell including two or more assembled units to assemble a patterned shell to engage with the bulb holder.
